(19) United States
(12) Patent Application Publication
(10) Pub. No.: US 2009/0291685 A1
(43) Pub. Date: Nov. 26, 2009

(54) RADIO COMMUNICATION SYSTEM, COMMUNICATION DEVICE, AND RELAY DEVICE

(75) Inventor: Tetsuro Morimoto, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/091,558

(22) PCT Filed: Oct. 26, 2006
(86) PCT No.: PCT/JP2006/321363

§ 371 Date: Apr. 25, 2008

(30) Foreign Application Priority Data
Oct. 31, 2005 (JP) 2005-316104

(51) Int. Cl. H04W 36/00

(52) U.S. Cl. 455/436

(57) ABSTRACT

Disclosed is a technique in which, when no reliability exists between a previous communication device and a destination communication device with respect to a mobile terminal, a context which is setting information needed for making a connection of the mobile terminal to a network is transferred at a high speed from the previous communication device to the destination communication device. According to this technique, before movement, a mobile terminal 101 is connected to a previous AR (access router) while, after the movement, it is connected to a destination AR 202 having no direct reliability with the previous AR 201. A relay AR 501 has the reliability with both the previous AR 201 and the destination AR 202 and relays connection therebetween. The previous AR 201 transmits a context through the relay AR 501 to the destination AR 202 before the movement of the mobile terminal 101. After the reception of the context, upon receipt of an active request for a connection from the mobile terminal 101 which has moved, the destination AR 202 authenticates the mobile terminal 101 by use of the context it has received.

### TECHNICAL FIELD

The present invention relates to a radio communication system, communication device, and relay device, designed to transmit and receive a context which forms setting information such as terminal information and communication connection conditions on a mobile terminal including a portable telephone so that the mobile terminal is capable of maintaining calling, call arrival and communications while it is on movement.

### BACKGROUND ART

As a conventional context mobile technology, there has been known a technique in which a context which is information needed for communications by mobile terminals is transferred directly between a previous access router (AR) and a destination access router (for example, see Non-Patent Document 1).

FIG. 9 is an illustration of an implementation of a communication with a communication partner 102 while a mobile terminal 101 (before-movement 101-a, after-movement 101-b) is on movement, and a plurality of access routers are in connection with a network 103. The mobile terminal 101-a is made to carry out a radio communication using electric wave with respect to an access router (previous access router) 104 at some time point and make a connection through the access router 104 with a network for making a communication of voice or data with respect to the communication partner 102. After the movement, the mobile terminal 101-b makes a connection through an access router (destination access router) 105 with the communication partner 102.

In the technique disclosed in the Non-Patent Document 1, the access router 104 transfers, to the access router 105, the context which is setting information it holds or making a connection of the mobile terminal with the network 103, so the access router 105 makes a connection between the mobile terminal 101-b, which has moved, and the network 103.

The Non-Patent Document 1 discloses, as met hods of transferring a context, two types of methods: a method using a context request and a method using a context advertisement.

The first method using a context request will be described with reference to FIG. 10.

In FIG. 10, the mobile terminal 101 change the connection-accepting side with the network from a previous access router 201 to a destination access router 202.

First, the mobile terminal 101-a starts to move. Following this, the mobile terminal 101-b after the movement transmits an active request (CTAR: Context Transfer Active Request Message) to a destination access router 202. This message includes a before-movement address (MN's Previous IP Address) for identifying the mobile terminal 10 authentication data (MN Authorization Token) for conforming the fact of a message from the mobile terminal 101 and an address (Previous AR IP Address) of the previous access router 201.

The previous access router 202, which has received the active request, transmits a context request (CT-Req: Context Transfer Request Message) to the previous access router 201. The data included in the active request is used as an address of the previous access router 201 which is a destination of transmission of the message. The context request intactly contains the before-movement address of the mobile terminal 101 included in the active request and the authentication data for confirming the fact of a request from the mobile terminal 101.

The previous access router 201, which has received the context request, confirms the authentication data included in the context request and checks whether or not the request is from the mobile terminal 101. If the request is correctly from the mobile terminal 101, the previous access router 201 transmits a context response (CTD: Context Transfer Data Message) to the destination access router 202 which is the context request addresser. This context response contains key data for confirming the authentication data for the authentication of the message from the mobile terminal 101 and a context which is information for the connect ion of the mobile terminal 101 with the network.

The above-mentioned operations form a procedure to be conducted until the destination access router 202 receives a context from the previous access router 201.

The second method using a context advertisement will be described with reference to FIG. 11.

The mobile terminal 101-a notifies the address of the destination access router 202 to the previous access router 201 before movement. A CTAR is used for this message. The Non-Patent Document 1 discloses that the address of the destination access router 202 or the address of the previous access router can be included in the CTAR.

The previous access router 201 transmits a context advertisement (CTD) to the destination access router 202 on the basis of information from the mobile terminal 101. This CTD is the same message as the context response mentioned with reference to FIG. 10. Although the Non-Patent document 1 handles it as the same message, since the messages are different in application from each other in this specification, the messages will be referred to separately.

The destination access router 202, which has received the context advertisement, waits for the transmission of an active request from the mobile terminal 101. This active request is the same message as the active request mentioned with reference to FIG. 10.

The destination access router 202, which ha received the active request from the mobile terminal 101-b conforms the authentication data on the mobile terminal 101 through the use of the key data included in the context advertisement and, if it is correct, places the mobile terminal 101-b into connection with the network. In addition, the destination access router 202 transmits a context advertisement response (CTDR: Context Transfer Data Reply) to the previous access router 201.

The previous access router 201, which has received the context advertisement response, knows that the mobile terminal 101 has moved to the place of the destination access router 202.

The above-mentioned operations form a procedure of transmitting a context (advertising a context) to the destination access router 202.

FIG. 12 is an illustration of a configuration of an access router, which is a communication device disclosed in the Non-Patent Document 1, and an operation thereof.

First of all, with regard to the case of a flow of a message in FIG. 10 according to the above-mentioned first method, a description will be given with respect to each component of the access router in FIG. 12 and an operation thereof.

In the destination access router 202, a message receiving unit 301 first receives an active request from the mobile terminal 101 and sends it to a decryption processing unit 302. Because of no encryption of the active request, the encryption processing unit 302 hands over the active request t a message analyzing unit 303 without carrying out any processing. The message analyzing unit 303 conducts the analysis processing on the message and refers to a terminal information retaining unit 304 to confirm whether or not it has key data and a context. In the case of the flow of a message in FIG. 10, because it does not have key data and a context, a message creating unit 305 creates a context request. Moreover, an encryption processing unit 306 encrypts the context request so that the previous access router 201 can decrypt it. Still moreover, a message transmitting unit 307 transmits the context request.

In the previous access router 201, a message receiving unit 301 receives the context request and, since it encrypted, a decryption processing unit 302 decrypts it. A message analyzing unit 303 takes out key data from a terminal information retaining unit 304, and an authentication processing unit 308 carries out the confirmation processing on the authentication data. If the authentication data is correct, a message creating unit 305 creates a context response including the context and the key data, and an encryption processing unit 306 carries out the encryption processing on the context response so that the destination access router 202 can decrypt it. Subsequently, a message transmitting unit 307 transmits it.

In the destination access router 202, the message receiving unit 301 receives the context response transmitted from the previous access router 201, and the decryption processing unit 302 carries out the decryption processing thereon, and the message analyzing unit 303 conducts the analysis processing thereon. The received context and key data are retained in the terminal information retaining unit 304. Moreover, a mobile terminal communication setting unit 309 sets a communication condition on the basis of the context, thereby making a connection of the mobile terminal 101 with the network.

Furthermore, with regard to the case of a flow of a message in FIG. 11 according to the above-mentioned second method, a description will be given of each component of the access router in FIG. 12 and an operation thereof.

The previous access router 201 receives a CTAR from the mobile terminal 101 in advance before the movement of the mobile terminal 101 and recognizes the address of the destination access router 202. The message analyzing unit 30 conducts the analysis processing on this message and takes out the key data and the context from the terminal information retaining unit 304, and the message creating unit 305 create a context advertisement, and the encryption processing unit 306 carries out the encryption processing thereon, and the message transmitting unit 307 transmits it.

In the destination access router 202, the message receiving unit 301 receives the context advertisement transmitted from the previous access router 201 and the decryption processing unit 302 conducts the decryption processing thereon, and the message analyzing unit 303 analyzes it, and the terminal information retaining unit 304 retains the context and the key data.

In response to the movement of the mobile terminal 101, in the destination access router 202, the message receiving unit 301 receives an active request from the mobile terminal 101-b after the movement. Usually, this active request is not encrypted, so the message analyzing unit 303 conducts the analysis processing without carrying out the decryption processing. Since the data on the terminal is retained in the terminal information retaining unit 304, the authentication processing unit 308 confirms the authentication data while referring to this data and, if it is correct, the mobile terminal communication setting unit 309 sets a communication condition. Thus, the mobile terminal 101 is placed into connection with the network.

In addition, in the destination access route r 202, the message creating unit 305 creates a context advertisement response and the encryption processing unit 306 carries out the encryption processing thereon and the message transmitting unit 307 transmits it to the previous access router 201.

As described above, the context is transferred between the access routers according to the movement of the mobile terminal 101, which enables the mobile terminal 101 to make a communication with the communication partner.

Non-Patent Document 1: Context Transfer Protocol (draft-ieft-seamoby-ctp-11.txt August, 2004)

However, since the above-described configuration requires that the previous access router 201 and the destination access router 202 are capable of mutually carrying out the encryption processing and the decryption processing, there is a need to exchange the information required for the encryption processing and the decryption processing. Although it is also possible that the exchange of the information required for the encryption processing and the decryption processing is made through the use of a technique such as IKE (Internet Key Exchange) after a need exists for the transmission of a message, in this case, the exchange of the information for the encryption processing and the decryption processing is made before the transfer of the context, which creates a problem in that there is a need for the mobile terminal 101 to wait until the resumption of communication after the movement.

In this specification, the “relationship in the cross-holding of the information needed for the encryption processing and decryption processing” between access routers is expressed as “the reliability is established”. The reason why the relationship of trust is required between the previous access router and the destination access router is because a message to be exchanged between access router contains information at which one does not want other persons to take a surreptitious glance. For example, in a case in which the key data included in the context response or the context advertisement is stolen, there is a possibility that a different terminal impersonates the mobile terminal 101 through the use of the stolen key data.

### DISCLOSURE OF THE INVENTION

It is an object of the present invention to provide a context transferring technique capable of, when the connection-accepting side of a mobile terminal moves from the previous access router to the destination access router, preventing unreliable other persons or different de vices from taking a surreptitious glance and of shortening the time for which the communication by a mobile terminal interrupts.

For solving the above-mentioned conventional problems, according to a first invention, there is provided a radio communication system comprising a first communication device on a previous side which is connected through radio to a mobile terminal, a second communication device on a destination side with which the mobile terminal is placed through radio into connection after movement and at least one relay device made to relay a connection between the first communication device and the second communication device, with only devices having reliability with each other being connectable with each other, wherein the first communication device does not have direct reliability with the second communication device and it transmits terminal information on the mobile terminal through at least one relay device to the second communication device, with a message being transferred by use of the relationship between the first communication device and the relay device and between relay device and the second communication device, which have already the reliability with each other, which can omit a procedure and time needed for establishing new reliability, thereby enabling the terminal information to be sent from the first communication device to the second communication device in a short period of time.

In the radio communication system according to a second invention, combined with the first invention, when the first communication device transmits the terminal information, the second communication device which is the destination of the mobile terminal is already specified and the specified second communication device is a transmission addressee of the terminal information and a message is transferred through the relay device having the reliability, which can omit procedure and time needed for establishing new reliability, thereby enabling the terminal information to be sent from the first communication device to the second communication device in a short period of time.

In the radio communication system according to a third invention, combined with the first invention, when the first communication device transmits the terminal information, the second communication device which is not specified is a transmission addressee of the terminal information, wherein, when the destination of the mobile terminal is not determined and the terminal information is advertised toward one or more second communication devices assumed as the destination thereof, the terminal information is advertised t rough the relay device having the reliability, which enables the transmission in a shorter period of time in comparison with the transmission after the establishment of new reliability.

In the radio communication system according to a fourth invention, combined with the second invention, upon receipt of a connection request from the mobile terminal, the second communication device transmits a request message which is for the transmission of the terminal information to the second communication device, through at least one relay device to the first communication device and, upon receipt of the request message from at least the one relay device, the first communication device authenticates the mobile terminal through the use of the request message and transmits the terminal information through at least the one relay device to the second communication device. This enable omitting a procedure and time needed for establishing new reliability between the first communication device and the second communication device, which allows the terminal information to be sent from the first communication device to the second communication device in a short period of time.

In the radio communication system according to a fifth invention, combined with the first invention, the first communication device transmits the terminal information through at least one relay device to the second communication device before the movement of the mobile terminal and, when receiving a connection request from the mobile terminal after the reception of the terminal information from at least the one relay device, the second communication device authenticates the mobile terminal on the basis of the terminal information and makes a connection of the mobile terminal. Since the terminal information arrives at the second communication device in advance before the movement of the mobile terminal to the second communication device, a permission of the authentication and the connection can be issued when the mobile terminal moves and trans its the connection request to the second communication device.

In the radio communication system according to a sixth invention, combined with the first invention, the second communication device transmits a response message for the notification of the connection of the mobile terminal through at least the one relay device to the first communication device after the connection of the mobile terminal. This allows the first communication device to know the fact that the mobile terminal has moved to a different communication device, in this case, the second communication device in a manner such that the movement of the mobile terminal to the second communication device is notified to the first communication device.

In the radio communication system according t a seventh invention, combined with the first invention, the first communication device transmits the terminal information to at least one relay device before the movement of the mobile terminal and, upon receipt of a connection request from the mobile terminal, the second communication device transmits a request message, which is for the transmission of the terminal information to the second communication device, to at least one relay device and, upon receipt of both the terminal information and the request message, at least the one relay device authenticates the mobile terminal by use of the request message and transmits the terminal information directly or through at least one different relay device to the second communication device, and in a case in which the terminal information on the mobile terminal advertised from the first communication device does not reach the second communication device which is a destination, when a relay device on that path receives both the terminal information and the request message before the request message from the second communication device reaches the first communication device, the relay device transmits the terminal information as a response to the request message to the second communication device in place of the first communication device. This enables the request message to arrive at the first communication device and the first communication device to transmit the terminal information and further allow the second communication device to receive the terminal information from the relay device before the arrival at the second communication device. That is, the mobile terminal can make a connection with the network promptly.

In the radio communication system according to an eighth invention, combined with the first invention, the first communication device transmits the terminal information to at least one relay device before the movement of the mobile terminal while, upon receipt of a connection request from the mobile terminal, the second communication device transmits a request message, which is for the transmission of the terminal information to the second communication device, to at least the one relay device, and upon receipt of both the terminal information and the request message, at least the one relay device authenticates the mobile terminal by use of the request message and transmits a response message for the notification of the occurrence of a request for the terminal information on the mobile terminal directly or through at least one different relay device to the first communication device, and the relay device which has received the terminal information from the first communication device or the request message from the second communication device returns the terminal information to the second communication device and further returns a response message to the first communication device. Thus, the first communication device can recognize the completion of the movement of the mobile terminal.

In the radio communication system according to a ninth invention, combined with the first invention, the first communication device transmits the terminal information to at least one relay device before the movement of the mobile terminal and, upon receipt of the terminal information, at least the one relay device transmits a terminal information retention message for the notification of retention of the terminal information directly or through at least on different relay device to the second communication device while, upon receipt of both the terminal information retention message and the connection request from the mobile terminal, the second communication device transmits a request message, which is for the transmission of the terminal information to the second communication device, to at least one relay device which retains the terminal information, and at least the one relay device which retains the terminal information and which has received the request message authenticates the mobile terminal by use of the request message and transmits the terminal information directly or through at least one different relay device to the second communication device, wherein, in a manner such that a relay device which does not transfer the terminal information due to a limit of a transfer range of the terminal information set by the first communication device transmits the terminal information retention message for the notification of the fact of the retention of the terminal information to a different communication device, the second communication device to which the mobile terminal has moved can select the relay device, which has transmitted the terminal information retention message, as a destination of the transmission of the request message. In this way, the second communication device can acquire the terminal information from the relay device earlier than the case of the transmission of the request message to the first communication device.

In the radio communication system according to a tenth invention, combined with the first invention, the first communication device transmits the terminal information to at least one relay device before the movement of the mobile terminal and, upon receipt of the terminal information, at least the one relay device transmits a terminal information retention message for the notification of the retention of the terminal information directly or through at least one different relay device to the second communication device while, upon receipt of both the terminal information retention message and a connection request from the mobile terminal, the second communication device transmits a request message, which is for the transmission of the terminal information to the second communication device, to at least one relay device which retains the terminal information, and at least said one relay device which retains the terminal information an which has received the request message

authenticates said mobile terminal by use of the request message and transmits a response message, which is for notification of a request of the terminal information on the mobile terminal, directly or through at least one different relay device to the first communication device, wherein the relay device which has advertised the fact of the retention of the terminal information by transmitting the terminal information retention message receives the request message and communicates the terminal information to the second communication device and transmits a response message to the first communication device, thereby enabling the first communication device to know the completion of the movement of the mobile terminal.

In the radio communication system according to a eleventh invention, combined with the ninth or tenth invention, at least the one relay device transmits the terminal information retention message to the second communication device, which is not specified, at the transmission of the information retention message wherein, at the advertisement of the terminal information retention message, the terminal information retention message is transmitted to one or a plurality of communication devices or relay devices, which have reliability, without being transmitted toward a specified communication device. This achieves a higher possibility that the terminal information message arrives at a communication device serving as a second communication device which becomes a destination of the mobile terminal or at a relay device.

In the radio communication system according to a twelfth invention, combined with the first invention, when receiving a connection request from the mobile terminal after receiving the terminal information from at least one relay device, the second communication device authenticates the mobile terminal on the basis of the terminal information and makes a connection thereof and transmits the terminal information directly or through at least one different relay device to third communication device which becomes a destination at further movement of the mobile terminal, wherein the second communication device which is the destination of the mobile terminal advertises the terminal information or transmits it in response to a request message in a manner such that the second communication which is the destination of the mobile terminal serves in turn as a previous position. This enables transmitting the terminal information promptly to a destination communication terminal to continuous movement of the mobile terminal.

In the radio communication system according to a thirteenth invention, combined with the first invention, the terminal information includes a count value of the number of hops and an upper limit value of the number of hops, and this allows setting limits to a range of arrival of the terminal information at the advertisement of the terminal information.

In the radio communication system according to a fourteenth invention, combined with the thirteenth invention, the first communication device allocates an upper limit value for each relay device to which the terminal information is transmitted, which enables the range of the relay device at which the terminal information arrives to be adjusted to a direction of the movement of the mobile terminal.

In the radio communication system according to a fifteenth invention, combined with the first invention, the first communication device transmits the terminal information through at least one relay device to the second communication device before the movement of the mobile terminal and, when receiving a connection request from the mobile terminal after receiving the terminal information from at least the one relay device, the second communication device authenticates the mobile terminal by use of the terminal information and makes a connection of the mobile terminal and, after the connection of the mobile terminal, transmits a response message for the notification of the connection of the mobile terminal through at least one relay device to the first communication device, with the terminal information including the record of the number of hops taken until the arrival at the second communication while the response message including the number of hops recorded in the terminal information, wherein the number of hops taken until the terminal information transmitted from the first communication device arrives at the second communication device is read from the count value of the number of hops recorded in the terminal information and his value is transmitted to the first communication device in a state put in the response message. In this way, the first communication device can know the number of hops taken until the communication device which is the destination of the mobile terminal. This information can be used for the selection of an upper limit value of the number of hops at the next advertisement of the terminal information.

In the radio communication system according to sixteenth invention, combined with the first invention, the first communication device transmits first terminal information through at least one relay device to the second communication device before the movement of the mobile terminal and, when receiving a connection requirement from the mobile terminal after receiving the first terminal information from at least the one relay device, the second communication device authenticates the mobile terminal by use of the first terminal information and makes a connection of the mobile terminal and transmits second terminal information directly or through at least one different relay device to a third connect ion device which becomes a destination in the case of further movement of the mobile terminal, with the first terminal information transmitted from the first communication device including the record of the number of hops taken until the arrival at the second communication device while, in the second terminal information transmitted from the second communicate on device, the number of hops recorded in the first terminal information and taken until the arrival at the second communication device or a value larger than this number of hops being set as an upper limit value of the number of hops of the second terminal information, wherein the second communication device reads the count value of the number of hops included in the terminal information from the first communication device, the second communication device has received as a destination communication device, and utilizes it as an upper limit value of the number of hops at the transfer of the terminal information when the second communication device advertises the terminal information as a previous communication device. This allows a selection of an upper limit value of the number of hops according to a movement situation of the mobile terminal.

In the radio communication system according to a seventeenth invention, combined with the above-described inventions, the request message includes a count value of the number of hops and an upper limit value of the number of hops. This enables restricting an arrival range of the request message.

In the radio communication system according to an eighteenth invention, combined with the first invention, the first communication device transmits the terminal formation to at least one relay device before the movement of the mobile terminal and, upon receipt of a connection request from the mobile terminal, the second communication device transmits a request message, which is for the transmission of the terminal information to the second communication device, to at least one relay device and, upon receipt of both the terminal information and the request message, at least the one relay device authenticates the mobile terminal by use of the request message and transmits a response message for the notification of the occurrence of a request for the terminal information on the mobile terminal directly or through at least one different relay device to the first communication device, with the terminal information transmitted from the first communication device including the record of a first number of hops taken until the arrival at the relay device, the request message transmitted from the second communication device including the record of a second number of hops taken until the arrival at the relay device and the response message including both the first number of hops and the second number of hops or the information on the sum total of the numbers of hops, and the relay device which has receive both the terminal information and the request message acquires the number of hops between the first communication device and this relay device from the terminal information and acquires the number of hops between the second communication device and this relay device from the request message and notifies the acquired number of hops between the first communication device and the second communication device to the first communication device through the use of the response message. In this way, the first communication device can recognize the number of hops up to the communication device which is a destination of the mobile terminal. This information can be used for a selection of an upper limit value of the number of hops at the next advertisement of the terminal information.

In the radio communication system according to a nineteenth invention, combined with the first invention, the first communication device transmits first terminal information to at least one relay device before the movement of the mobile terminal and, upon receipt of a connection request from the mobile terminal, the second communication device transmits a request message, which is for the transmission of the first terminal information to the second communication device, to at least one relay device and, upon receipt of both the first terminal information and the request message, at least the one relay device authenticates the mobile terminal by use of the request message and transmits second terminal information directly or through at least one different relay device to the second communication device, with the first terminal information transmitted from the first communication device including the record of a first number of hops taken until the arrival at the relay device, the request message transmitted from the second communication device including the record of a second number of hops taken until the arrival at the relay device and the second terminal information including both the first number of hops and the second number of hops or the information on the sum total of the numbers of hops, and the relay device which has receive both the terminal information and the request message acquires the number of hops between the first communication device and this relay device from the terminal information and acquires the number of hops between the second communication device and this relay device from the request message and transmits the acquired number of hops between the first communication device and the second communication device in addition to the terminal information to be transmitted to the second communication device, and the second communication device which has received this terminal information uses the acquired number of hops between the first communication device and the second communication device as an upper limit of the number of hops of the terminal information to be transmitted from the second communication device. Thus, the second communication device can set the upper limit of the number of hops at a value suitable for the arrival at the next destination communication device.

It is also acceptable that the terminal information includes a context on the mobile terminal.

In addition, in a case in which the radio communication system is designed to append a header indicative of transfer addressee through the encapsulation of a packet at the time of the transfer of the terminal information, the request message, the response message and the terminal information retention message, it is possible to transfer a message transmitted from the previous side in an intact state.

Still additionally, in a case in which the radio communication system is designed to rewrite the transmitted side address into a transferred side address at the time of the transfer of the terminal information, the request message and the response message and to retain the transmitted side address in the message, it is possible to carry out the transfer without encapsulating the message.

Yet additionally, in a case in which the radio communication system is designed to rewrite the transmitting side address into a transferring side address at the time of the transfer of the terminal information, the request message and the terminal information retention message and to retain the transmitting side address in the message, it is possible to facilitate the transmission of a message as a response to a message transmitting side.

Moreover, in a case in which the radio communication system is designed to hold, in the message, transfer flag information indicative of there being a need to transfer the terminal information, the request message, the response message and the terminal information retention message, it is possible to make an easy judgment as to whether or not the message is required to be transferred.

Still moreover, in a case in which the radio communication system is designed to include at least one address of a relay device on a path for transfer of the message in the terminal information, the request message and the response message, the message transmitting side can specify a portion of or the whole of a message transfer path.

Yet moreover, in a case in which the radio communication system is designed to include all the addresses of relay devices on a transfer path in the terminal information, the request message and the response message and further include transfer sequence, the message transmitting side can specify a message relay path.

Furthermore, in a case in which the radio communication system is designed to include the addresses of transfer addressee and transfer scheduled addressee from a relay device in the terminal information, the request message, the response message and the terminal information retention message, the relay device which tries to carry out the transfer can know the relay device to which the message was already transferred or to which the message is to be transferred, thereby avoiding the duplicate transmission of the message to the relay device.

Still furthermore, in the radio communication system, as well as the terminal information, the request message and the response message, the terminal information retention message includes a count value of the number of hops and an upper limit value of the number of hops. This enables restricting a range of the arrival of the terminal information retention message at the transmission of the terminal information retention message.

According to the present invention, even if the relationship of trust is not established between previous communication device, with which a mobile terminal is in connection, and a destination communication device with which the mobile terminal is to be connected, a context is transferred through a communication device having the established relationship of trust with respect to each of the previous communication device and the destination communication device, which can carry out smooth handover of the mobile terminal.

### BRIEF DESCRIPTION OF THE DRAWINGS

FIG. 1 is a block diagram showing a configuration of a communication device according to an embodiment of the present invention.

FIG. 2 is an illustration of a message flow in a case in which a context according to an embodiment of the present invention is shifted through the use of a transfer message.

FIG. 3 is an illustration of a message flow in a case in which a context according to an embodiment of the present invention is advertised through the use of a transfer message.

FIG. 4 is an illustration of a message flow in a case in which an upper limit of the number of hops of an advertisement message according to an embodiment of the present invention is changed by a transferred side.

FIG. 5 is an illustration of a message flow in a case in which a destination communication device according to an embodiment of the present invention makes an advertisement as a previous communication device.

FIG. 6 is an illustration of a message flow in a case in which a relay communication device according to an embodiment of the present invention makes a response to a request as proxy.

FIG. 7 is an illustration of a message flow in a case in which a relay communication device according to an embodiment of the present invention receives a context advertisement and advertises the retention of the context.

FIG. 8 is an illustration of a message flow in a case in which a relay communication device notifies the number of hops from a previous communication device to a destination communication device in an embodiment of the present invention through the use of a context advertisement response to the previous communication device.

FIG. 9 is a conceptual illustration of a state in which a mobile terminal is in connection with a network.

FIG. 10 is an illustration of a message flow in the case of a conventional context transfer.

FIG. 11 is an illustration of a message flow in the case of a conventional context advertisement.

FIG. 12 is a block diagram showing a configuration of a conventional communication device.

### BEST MODE FOR CARRYING OUT THE INVENTION

An embodiment of the present invention will be described hereinbelow with reference to the drawings.

### Embodiment

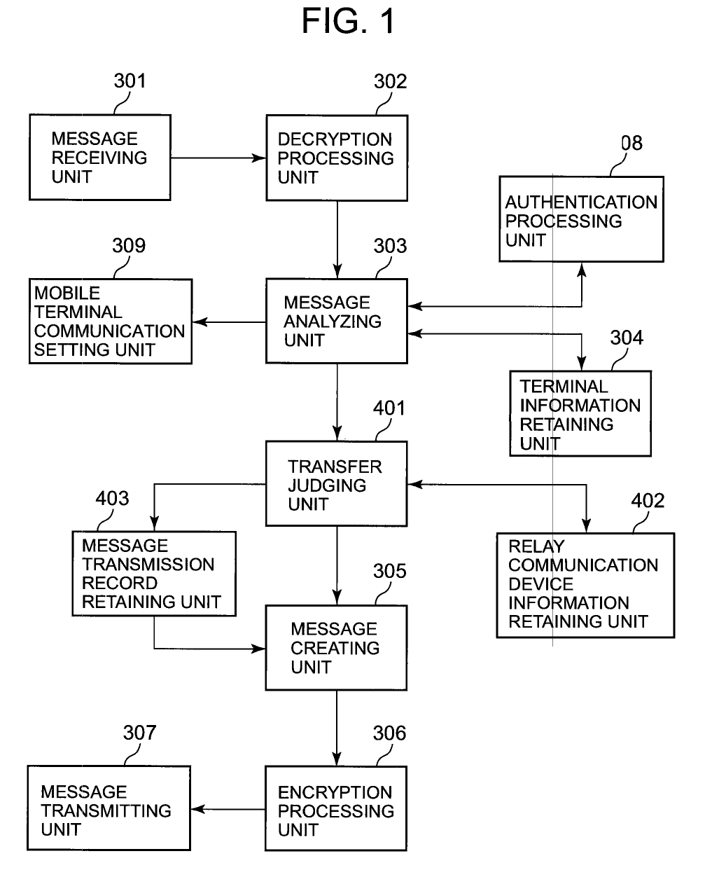

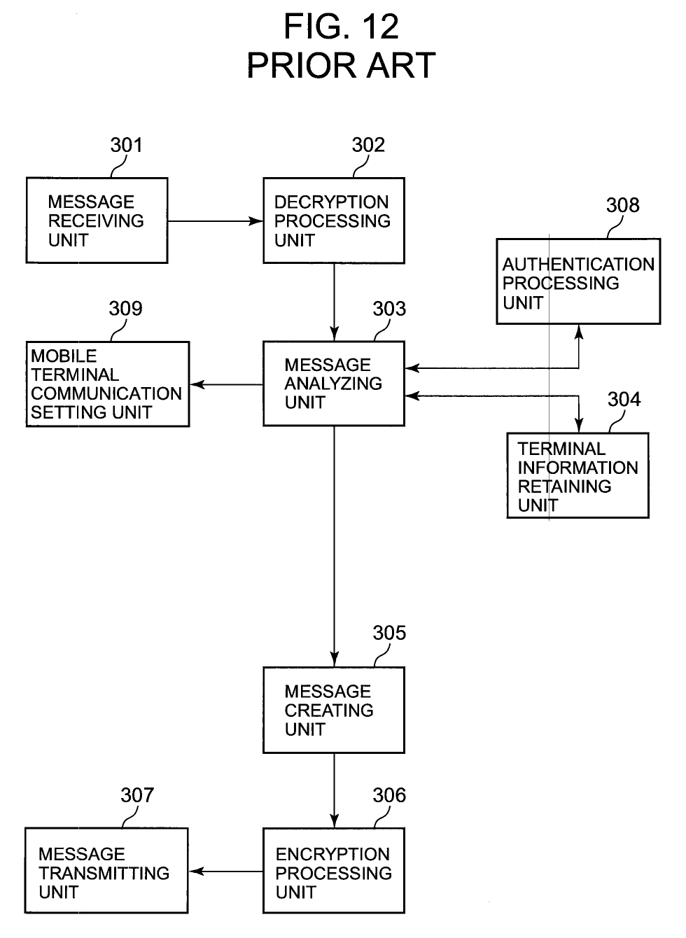

FIG. 1 is an illustration of a configuration of a communication device (access router) according to an embodiment of the present invention. In FIG. 1, the same components as those in FIG. 12 are designated at the same reference numerals, and the description thereof will be omitted.

In FIG. 1, a transfer judging unit 401 makes a judgment as to whether or not there is a need to transfer a message. A relay communication device information retaining unit 402 retains information on a communication device having the reliability for determining a transfer addressee of a message. A message transmission record retaining unit 403 records a transmission addresser and transfer addressee at the transfer of a message and retains information for determining a transmission addressee of a response message.

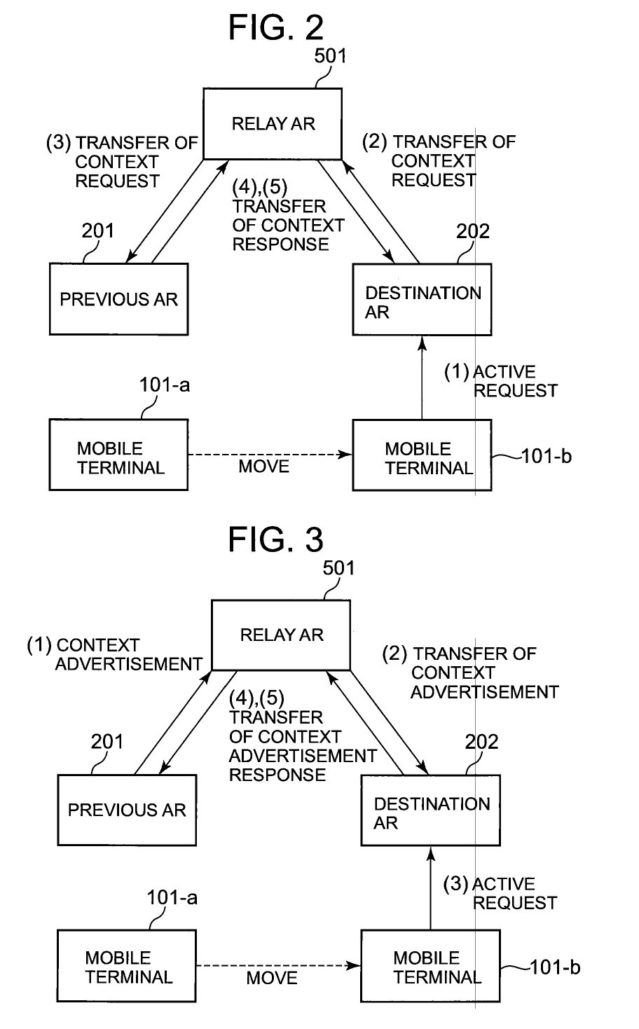

FIG. 2 is an illustration of a flow of a message when a request for a context is made through the use of transfer of a message. The same components as those in FIG. 10 will be described using the same reference numerals.

In response to a movement of a mobile terminal 101, the connection side thereof shifts from a previous access router to a destination access router 202, and the mobile terminal 101-b transmits an active request to the destination access router 202. In a case in which no relationship of trust exists between the destination access router 202 and the previous access router 201, the destination access router 202 cannot send a context to the previous access router 201.

Usually, in a case in which two are in an adjacent state and a large number of mobile terminals move between these access routers, there is a high possibility that the reliability is established in advance between these access routers. With respect to the reliability, for example, it is considered that the SA (Security Association) of IPsec is established in advance so that messages are exchanged between access routers without a surreptitious glance.

On the other hand, as a situation mentioned with reference to FIG. 2, for example, there is considered a case in which a mobile terminal jumps over the connection with neighbor access router and reaches and connects with further distant access router because of extremely high movement or a case in which a mobile terminal passes through an exceptional path and moves to an incogitable access router.

The establishment of reliability among all access routers is impractical in view of efficient operations of resources. Moreover, from the viewpoint of the information security, it is undesirable to, after the reliability is once established, maintain the same reliability permanently. It is considered as operations to review or update the reliability periodically and remove it when unnecessary.

Accordingly, it is assumed as a situation that the reliability is always established between access routers, a mobile terminal moves frequently therebetween, while the reliability is not established between access routers distant from each other or between access routers which are adjacent to each other but between which no movement route of a mobile terminal exists.

Thus, when no reliability exists between the access routers, there is a need to establish the reliability newly depending upon a movement route of a mobile terminal. However, usually, it takes a time to set up a procedure or the establishment of the new reliability. For example, in the case of IPsec, although IKE (Internet Key Exchange) is employed, it is known that it takes a long time to establish the SA of IPsec.

According to the present invention, as shown in FIG. 2, in a case in which the destination access router cannot transmit a context request directly to the previous access router 201, the destination access router 202 transfers the context request to relay access router 501 having the reliability.

At this time, the destination access router 202 receives an active request from the mobile terminal 101-b, wherein the message analyzing unit 303 conducts the analysis on it and, without transmitting the context request directly to the previous access router 201, the transfer judging unit 401 makes a judgment that there is a need to transfer it and acquires the information on a transferable access router (relay access router) from the relay communication device information retaining unit 402 and determines a transfer addressee. Moreover, the message creating unit 305 creates transfer message on the context request and the encryption processing unit 306 encrypts the transfer message and the message transmitting unit 307 transmits it.

The relay access router 501, which has received the transfer of the context request, confirms that the context request transfer message is not directed to this communication device and transfers it to a different communication device. In FIG. 2, although the relay access router 501 transfers the context request to the previous access router 201, it is also acceptable that a plurality of access routers for relay exist between the destination access router 202 and the previous access router 201.

In this case, the relay access router 501 con ducts the decryption processing on the context request transfer message and analyzes the message and, if the judgment shows that there is a need to transfer it, creates and transmits a transfer message. That is, the relay access router 501 has the same configuration as that of the destination access outer 202 in FIG. 1 and the processing thereof is the same as that of the destination access router 202.

The previous access router 201, which has received the transfer of the context request, transmits the key data on the mobile terminal 101 and the context in a state included in a context response transfer message because this context request transfer message is addressed to this communication device.

At this time, in the previous access router 201, the message receiving unit 301 receives the context request transfer message and the decryption processing unit 302 carries out the decryption processing on it and the message analyzing unit 303 analyzes that it is a transfer message an that the context request is addressed to this communication device and confirms that the information on the mobile terminal 101 exists in the terminal information retaining unit 304, and the authentication processing unit 308 confirms that the request is right.

For carrying out a context response, the transfer judging unit 401 refers to the relay communication device information retaining unit 402 and makes a judgment that there is a need to transfer it and acquires the address of a relay communication device (access router) which is a transfer addressee, while the message creating unit 305 creates a transfer message for the context response and the encryption processing unit 306 carries out the encryption processing on it and the message transmitting unit 307 transmits it.

The relay access router 501, which has received the transfer of the context response, confirms that this context response transfer message is not a message directed to this communication device and transfers it to a different communication device. Also in this transfer message, it is also acceptable that a plurality of access router for relay exist between the previous access router 201 and the destination access router 202.

At this time, the relay access router 501 conducts the same processing as that in the case of the context request transfer message and then transmits the context response transfer message.

The destination access router 202, which has received the transfer of the context response, analyzes the transfer message and the context response message and makes a connection of the mobile terminal 101-b with the network by use of the received context.

In this case, in the destination access router 202, the message receiving unit 301 receives the message and the decryption processing unit 302 carries out the decryption processing on it and the message analyzing unit 303 analyzes the transfer message and the context response message. Moreover, the key data and context included in the context response message are held in the terminal information retaining unit 304 and the context information is set in the mobile terminal communication setting unit 309, thereby enabling the mobile terminal 101-b to be connected to the net work.

A description will be given hereinbelow of a case of storing the whole of a message, which is to be transmitted, in a data area for a transfer message as a message transferring method.

The destination access router 202 creates a context request message addressed to the previous access outer 201 and, in a state where this message is set as a data area, creates a new message, addressed to the relay access route 501, and conducts the encryption processing on the message addressed to this relay access router 501 before transmitting it.

The relay access router 501, which has received this transfer message, conducts the decryption processing on this transfer message and takes out the context request message from the data area of the transfer message and analyzes it. At this time, since this analysis shows that the context request message is not directed to this communication device the relay access router 501 creates, in an intact state, transfer message directed to a different access router where the context request message forms a data area and conducts the encryption processing on it before transmitting.

In FIG. 2, although the relay access router 501 next transmits the transfer message to the previous access router 201, it is also appropriate that the relay access outer 501 further transmits the transfer message to a different relay access router.

The previous access router 201 receives this transfer message and conducts the decryption processing on it and extracts the context request message from the message data area and analyzes it. Since this analysis shows that this context request message is addressed to this communication device, the previous access router 201 conducts the authentication processing and others and creates a context response message addressed to the destination access router 202. In addition, the previous access router 201 creates a new message addressed to the relay access router here this context response message forms a data area and encrypts and transmits it to the relay access router 501.

The relay access router 501 carries out the same transfer processing as that in the case of the request message and transfers this context response message.

The destination access router 202 receives this transfer message and conducts the decryption processing and takes out the context response message from the message data area. Since this operation shows that this context response message is addressed this communication device, it can be processed as the context response message.

Furthermore, referring to FIG. 2, a description will be given hereinbelow of a case in which, for a transfer message, an address of a message-directed communication device is rewritten into an address of a transfer-receiving communication device and a message is created which includes the address of the message-directed communication device.

The destination access router 202 creates context request message directed to the previous access router 201. Since difficulty is encountered in carrying out the direct transmission, the address of the previous access router 201 is appended as a context request addressee to a portion of data in the context request message.

Since the context request message is directed to the previous access router 201 in this state, the destination address is changed to the relay access router 501. One or more relay access routers are usable. It is also acceptable that the destination access router 202 transmits a context request transfer message toward a plurality of relay access routers (communication devices) having the reliability.

The relay access router 501. which has received this transfer message, transfers the message to a different communication device because the address of the context request addressee in the message is different from the address of this communication device although the message is directed to this communication device.

In a new transfer message, as an addressee, there is set a communication device with the relay access router has the reliability.

It is also appropriate that the relay access router 501 transmits the transfer message to all the communication devices, with which it has the reliability, except the communication device which has transmitted the transfer message.

In a case in which the communication devices having the reliability includes a context request addressee communication device, it is also acceptable to transmit the transfer message to only the context request addressee communication device without transmitting to other communication devices.

When the previous access router 201 receives this transfer message and conducts the decryption processing hereon, a confirmation is made that the context-request address in the message is equal to the address of this communication device. Thus, the previous access router 201 carries out the same processing as that in the case of the reception of the context request. Concretely, the previous access router 20 confirms the authentication data and, if it is correct, create a context response message. Moreover, the previous access outer 201 transmits this context response message as a transfer message to the request addresser.

Referring to the configuration shown in FIG. 1, a description will be given of a flow of processing for the arrival of a context response message at the request addresser destination access router 202.

The message transmission record retaining unit 403 retains the identification information on a request message and the addresses of the transmission addresser and addressee as the record that the message creating unit 305 has created a message to the transfer addressee. After the transfer of the request message, at the reception of the response transfer message, the information for the identification of the request message is taken out from the response message, and the transmission addresser of the request transfer message is extracted from the message transfer record and is set as the destination of the response transfer message.

The message transmission record retaining unit 403 transfers the context response message along the opposite way of the context request message transfer route.

As a transfer message, the message creatin unit 305 creates a message including the address of the communication device which is the message addressee and the address of the communication device which is the message transmission addresser and, as a response to this message, create a response message including the address of the transmission addresser included in the message. The transfer judging unit 401 makes a judgment on the transfer of the message on the basis of the address of the message addressee communication device included in the message and makes a judgment on the transfer on the basis of the address of the transmission addresser communication device included in the response message to this message. This judgment case will be described with reference to FIG. 2.

The destination access router 202 creates context request message directed to the previous access router 201. Since a difficulty is encountered in carrying out the direct transmission, the address of the previous access router 201 which is a context request addressee and the address of this communication device which is the context request addresser are appended to a portion of the data in the context request message.

A difference from the example mentioned above is that the address of this communication device is appended to the context request transfer message.

The destination access router 202 changes the addressee of the context request message to the relay access router 501 and transmits the transfer message. One or more relay access routers each of which transmits the transfer message are usable.

The relay access router 501, which has received this transfer message, transfers the message to a different communication device since the address of the context request addressee in the message is different from the address of this communication device although it is a message directed to this communication device.

In a new transfer message, as the destination, there is set a communication device with which the relay access router 501 has the reliability.

It is also acceptable that the relay access outer 501 transfers the message to all communication device with the relay access router 501 has the reliability. However, it is preferable to transmit it to the communication devices except the communication device which has transmitted the transfer message.

In a case in which the communication devices having the reliability includes the communication device of the context request addressee, it is also acceptable to transmit the message to only the context request addressee communication device without transmitting to the other communication devices.

When the previous access router 201 receives this transfer message and carries out the decryption processing thereon, a confirmation is made that the address of the context request addressee in the message agrees with the address of this communication device, and the processing at the reception of the context request is conducted. Concretely, the previous access router 201 authenticates the authentication data and, if it is correct, creates a context response message.

Moreover, the address of the request addresser is appended to this context response message. As the address of the request addresser, there is used an address appended to the context request transfer message. It is preferable that the transmission addressee of the transfer message is the transmission addresser of the context request transfer message.

It is also acceptable to send the context response transfer message to all the access routers (communication devices) having the reliability.

Upon receipt of the contest response transfer message, the relay access router 501 takes out the address of the context request addresser included in the transfer message and makes a transfer judgment.

Since the address of the context request addresser (the address of the destination access router 202) is included in the response message, without using the message transmission record retaining unit 403, the relay access rout r 501 can make the transfer so that the context response arrives at the request addresser.

Moreover, even if the context response transfer message does not arrive at the destination access router 202 of the context request addresser along the opposite route of the context request transfer message, it can arrive along a different route.

Incidentally, even in a case in which the address of the context request addresser is included in the context response message, it is also acceptable that the message transmission record retaining unit 403 is held in the communication device.

Upon receipt of the context response transfer message, the destination access router 202 conducts the decryption processing and analyzes it through the use of the message analyzing unit 303 and retains the information in the terminal information retaining unit 304 and sets the context information in the mobile terminal communication setting unit 309 and makes a connection of the mobile terminal 101 with the network.

Furthermore, a description will be given hereinbelow of a communication device for creating, as a transfer message, a message including the information indicative of the fact that there is a need to transfer a message.

For example, in a manner such that information such as a transfer flag is added to a message, the message analyzing unit 303 first checks only this transfer flag, which enables making a judgment as to whether or not to analyze it as a transfer message.

This can achieve an increase of the speed of the message analysis processing.

Furthermore, a description will be given hereinbelow of a communication device designed to create, as a transfer message, a message indicative of the upper limit of the number of hops of the message transfer.

For example, in the case of the IP (Internet Protocol), the information such as TTL or Hop Limit is indicative of the upper limit of the number of hops. By employing a method of subtracting this information included in a packet at the relay of the packet by a router and inhibiting the transfer when the information is below a given value, there is avoided a situation in which a packet is continuously transferred in a network for an indefinite time.

The upper limit of the number of hops which is to be given to a transfer message according to the present invention is information for determining the reliability of communication devices to be stepped over. Although the destination access router 202 has the reliability with the relay access router 501, the destination access router 202 does not have the reliability with the previous access router 201. The relay access router 501 has the reliability with the previous access router 201.

In this case, the transfer message where the upper limit of the number of hops is set at 0 reaches up to the relay access router 501. On the other hand, the transfer message where the upper limit of the number of hops is set at 1 can arrive at the previous access router 201 in a manner such that the relay access router 501 subtracts the number of hops and transfers it when the message creating unit 305 creates the transfer message.

For example, in a case in which the transfer message is carried through the use of the IP, the upper limit of the number of hops to be given to this transfer message does not agree with the number of times of transfer of the IP pack et. There is a case that, until the transfer message reaches the relay access router 501 from the previous access router 202, the IP packet passes through a plurality of routers and the number of times of transfer reaches more than once.

It is also acceptable that a communication d vice, for example, a previous access router or a relay access router, transmits a message to a plurality of communication devices, with which it has the reliability, at the transmission of a transfer message.

Accordingly, in a case in which the upper limit of the number of hops of the transfer message is large, there is a possibility that the message is transferred to quite a number of communication devices.

Furthermore, a description will be given hereinbelow of a communication device designed to create, as a transfer message, a message which includes all the address f transfer addressee communication devices, so as to show a transfer sequence.

This is for appending the address of a repeating communication device in advance to a message in a case in which a communication device, which is a transfer message transmission addresser, or the repeating communication device knows a transfer route up to the message transmission addressee.

The relay communication device, which has received this transfer message, takes out the address of a communication device, to which the transfer message is transferred next to this communication device, from the message and creates a transfer message and transmits it to the next communication device.

Furthermore, a description will be given hereinbelow of a communication device in a case in which, as a transfer method, the relay communication device information retaining unit 402 prepares the information on all message-transferable communication devices at the transfer of a message and the message creating unit 305 creates a message for the transmission to all the prepared communication devices.

This is a method in which a communication device retains the information indicative of the communication devices with the reliability in the relay communication device information retaining unit 402 so as to take out the information on the communication devices from the relay communication device information retaining unit 402 at the transfer of a message, which is not addressed to this communication device, and transfer the message to all the relay communication devices.

Furthermore, as a transfer addressee determining method, a description will be given hereinbelow of communication devices in which the relay communication device information retaining units 402 mutually exchange the information on a list of communication devices used as repeating communication devices at the mutual transfer of messages between the message addressee communication device and the message addresser communication device and retain that information and uses it as the information for the determination of a transfer addressee communication device.

This is a method in which the destination access router 202 makes an inquiry at the previous access router 201 about the address of a relay access router (communication device) with which the previous access router 201 has the reliability, for example, in a situation that, when the destination access router 202 tried to transmit a context request to the previous access router 201, a difficulty is encountered in directly transmitting a context request message because of no reliability or in a situation that it takes a long time to establish the reliability newly.

Upon receipt of the information on the communication device with the reliability from the previous access router 201, the destination access router 202 finds a communication device common to a communication device with which this communication device has the reliability and, if it exists, transmits a transfer message to that communication device.

Moreover, it is also appropriate to employ a method in which the destination access router 202 transmits the information on a list of communication devices, with which this communication device has the reliability, to the previous access router 201, while the previous access router 201 selects, from this list, the communication device with the reliability and returns it.

Still moreover, in addition to the communication devices having the direct reliability, it is also acceptable to include communication devices having indirect reliability. For example, it is also appropriate to exchange the list information on communication devices with the direct and indirect reliability, which have the number of hops up to 2, and search, of these, the communication device having the common reliability to set that communication device as a message transfer route.

In this case, it is considered to make a direct communication of messages for exchanging a list of communication devices having the reliability between the destination access router 202 and the previous access router 201.

Furthermore, as a transfer addressee determining method, a description will be given hereinbelow of communication devices in which the relay communication device information retaining units 402 periodically, or at the occurrence of variation of state, exchange the list information on communication devices, which are used as repeating communication devices when communication devices adjacent to each other transfer messages mutually, and retain that information and use it as the information for determining a transfer addressee communication device when a need for the message transfer occurs.

This signifies that a communication device periodically, or at the occurrence of variation of state, trans its a list of communication devices, with which this communication device has the direct and indirect reliability, to a communication device having the direct reliability.

It is also acceptable that the information on the communication devices having the indirect reliability includes the number of hops needed for the arrival of a transfer message.

Since this information is exchanged between the communication devices having the reliability with each other, it can be exchanged in a state encrypted.

In addition, because of the exchange of the information on the communication devices having the indirect reliability, for example, in FIG. 2, before the transmission of transfer message, the destination access router 202 can know the fact that the previous access router 201 exists after the relay access router 501, and it can select the relay access router 501 as the transfer message transmission addressee.

Furthermore, referring to FIG. 3, a description will be given hereinbelow of a communication device in which the message creating unit 305 creates a message for advertising a transferable context and the transfer judging unit 401 makes a judgment for transferring a context advertisement message.

FIG. 3 is an illustration of a flow of a message in a case in which a context advertisement is made through the use of the transfer of a message. The same components as those in FIGS. 2 and 12 will be described with the same reference numerals.

The previous access router 201 transmits a context and key data on the mobile terminal 101 to the relay access router 501, with it has the reliability, through the use of a context advertisement message. The relay access router 501 transfers this context advertisement to the destination access router 202 having the reliability.

The relay access router 501 and the destination access router 202 receive the context advertisement message and retains the information on the context in the terminal information retaining units 304.

When the mobile terminal 101-b moves to the place of the destination access router 202 and transmits an active request, since the destination access router 202 already acquired the context and key data on the mobile terminal 101 through the transfer of the context advertisement, the destination access router 202 authenticates the mobile terminal 10 and establishes a connection of the mobile terminal 101-b with the network.

Moreover, the destination access router 202 transmits a context advertisement response message. The method for the arrival of context advertisement response at the previous access router 201 is similar to that in the case of the transfer of the context response.

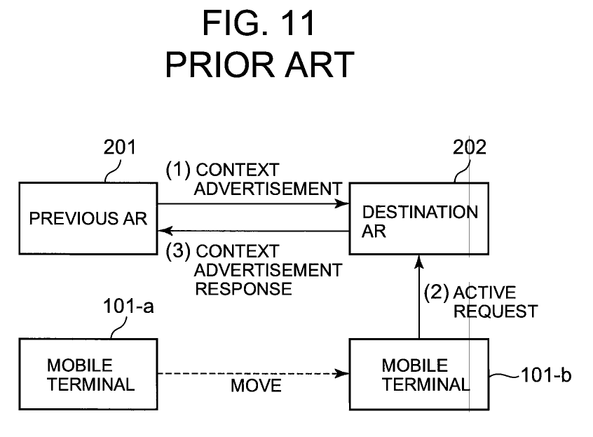

In the conventional case shown in FIG. 11, the address of the destination access router 202 is notified from the mobile terminal 101-a and an advertisement message is transmitted on the basis of this notification. In FIG. 3, it is acceptable that the advertisement message is transmitted without particularly specifying the transmission addressee of the context advertisement.

Moreover, it is also acceptable that the previous access router 201 transmits the context advertisement to all communication devices with it has the reliability.

Alternatively, it is also acceptable that, in a case in which the previous access router 201 already received the notification of the address of the destination access router 202 from the mobile terminal 101-a through the use of the CTAR or the like, the previous access router 201 transmit a context advertisement message specifying the number of transfer hops to the access router notified from the mobile terminal 101-a. In this case, even in a case in which the mobile terminal 101-a have moved to the plate of an access router further distant with respect to the access router notified by the mobile terminal 101-a, the possibility that the context has already been transferred becomes higher, which enables shortening the instantaneous disconnection interval by the hangover.

Furthermore, as a context advertise transfer message, a description will be given hereinbelow of a communication device in which the message creating unit 305 create a message including the information indicative of the upper limit of the number of times of message transfer.

The upper limit of the number of hops is included in a context advertisement message, and this value is reduced with respect to each transfer by a relay communication device.

Alternatively, the upper limit of the number of hops and the number of times of hop are included in a context advertisement message, and the upper limit and the actual number of times of hop are compared with each other at the transfer by a relay communication device, thereby making a judgment as to whether or not to carry out the transfer. When transferred, a transfer message where the number of times of hop is increased is created.

Furthermore, a description will be given hereinbelow of a communication device in which the message creating unit 305 determines the upper limit of the number of times of message transfer to transfer addressee communication devices at the transfer of the message to a plurality of transfer addressees and creates a message including this information.

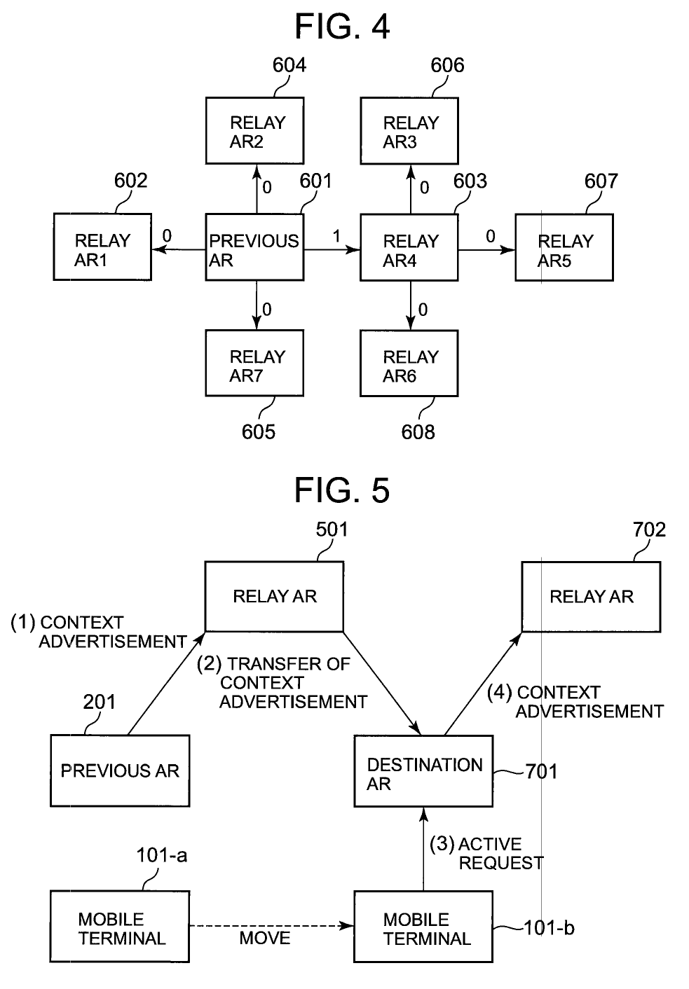

FIG. 4 explains a case in which a previous access router 601 changes the upper limit of the number of hops according to a transmission addressee when transmitting a context advertisement.

The previous access router 601 knows the plate of the access router where the mobile terminal has existed previously. This is because of the implementation of the context movement.

For example, let it be assumed that the previous access router 601 can anticipate that the mobile terminal next moves from a relay access router 1 (602) to the place of a relay access router 4 (603).

In this case, as an example, a context advertisement where the upper limit of the number of hops is set at 1 is transmitted to the relay access router 4 (603) while a context advertisement where the upper limit of the number of hops is set at 0 is transmitted to different relay access router 2 (604), relay access router 7 (605) and relay access router 1 (602).

Upon receipt of the context advertisement, the relay access routers 2, 7 and 1 (604, 605 and 602) do no carry out the transfer because the upper limit of the number of hops stands at 0. The relay access router 4 (603) subtracts 1 from the upper limit of the number of hops and creates transfer message to transmit it to the relay access routers 3, 5 and 6 (606, 607 and 608). The relay access routers 3, 5 and 6 (606, 607 and 608) do not carry out the transfer be cause the upper limit of the number of hops stands at 0.

The upper limits of the number of hops are not set to be equal to each other in this way, which enables adjusting the range of the arrival of the context.

Furthermore, a description will be given hereinbelow of a communication device in which, at the determination of the upper limit of the number of times of message transfer, the message creating unit 305 creates a transfer message by use of the previous number of hops notified from the mobile terminal 101.

The mobile terminal 101-b transmits an active request to the destination access router 202 at that destination, and the destination access router 202 adds, to a response message thereto, the information on the number of hops from the previous access router 201 up to the destination access router 202 and transits it to the mobile terminal 101-b.

Moreover, when the mobile terminal 101 moves, the mobile terminal 101-a stores the number of hops previously received as a response from a destination access router (in this case, the previous access router 201) and then transmits an active request message, to which the last number of hops is added, to the destination access router 202 to which it has moved next.

The destination access router 202, which has received the last number of hops from the mobile terminal 101, utilizes this last number of hops for the determination of the number of hops at the transmission of a context advertisement or context request.

For example, in a case in which the context advertisement already arrived at the destination access router 202, the context advertisement message in the destination access router 202 shows the number of hops (how many hops are needed) taken for this context advertisement at the arrival from the previous access router 201. On the other hand, known the last number of hops acquired from the mobile terminal 101, it is possible to determine the upper limit of the number of hops of a new context advertisement message by referring to the last number of hops and the last-but-one number of hops.

Incidentally, in a case in which the mobile terminal 101 accumulates a plurality of past numbers of hops an notifies this history information to an access router, the access router can determine the number of hops of a context advertisement message on the basis of this history information.

In addition, it is also appropriate that the mobile terminal 101 estimates a desirable value of the number of hops of the next context advertisement message according to the information on the speed of this terminal and others and notifies this value to an access router.

Furthermore, a description will be given hereinbelow of a communication device in which the message creating unit 305 creates a message including the information on a list of communication devices to which it has transferred message.

The upper limit of the number of hops in a context advertisement is set at a more-than-one value and the context advertisement is transmitted to a plurality of communication devices, there is a possibility that the communication devices receiving the same context advertisement exist. In particular, a larger upper limit of the number of hops more frequently causes the duplicate arrival of the context advertisement.

For this reason, the information indicative of a list of the addresses of the communications to which the advertisement has been transmitted is held in the context advertisement message.

For example, when the configuration shown in FIG. 4 is taken as an example, a previous access router 601 is made such that a context advertisement to be transmitted includes the addresses of relay access routers 1, 2, 4 and 7 (602, 604, 603 and 605) to which the previous access router transmits the context advertisement.

The relay access router 4 (603) further adds, to the context advertisement, the address of the relay communication device which receives the transfer from this communication device. That is, the addresses of the relay access routers 1, 2, 4, 7, 3, 5 and 6 (602, 604, 603, 605, 606, 607 and 608) are included as list information in the context advertisement message.

Since the communication device which has received this context advertisement can confirm no duplication of the transfer addressee and transmit an advertisement message, it is possible to avoid useless transmission of the advertisement message.

Furthermore, referring to FIG. 3, a description will be given hereinbelow of a communication device in which, upon receipt of a message for the advertisement of a context, the terminal information retaining unit 304 retains the information on the context and the number of hops for the transfer of this message and, when creating a response message to the advertisement message for notifying the fact of the movement of the mobile terminal on the advertised context, the message creating unit 305 creates a message including the number of hops for the transfer of the advertisement message.

This is for, in addition to the number of upper limits of the number of hops, additionally putting an element for counting the number of hops in a context advertisement message and conducting the addition with respect to each hop so that a communication device which performs the transfer can grasp what number hop this communication device is.

Moreover, the destination access router 202 which has received the context advertisement transmits a context advertisement response to the previous access router 201 in response to the movement of the mobile terminal 101-b, and the number of hops of the advertisement message is appended as information to the context advertisement response message and then transmitted.

That is, upon receipt of the context advertisement response message, the previous access router 201 which has transmitted the context advertisement message can know the destination access router 202 to which the mobile terminal 101 has moved at a given number of hops.

Owing to this context advertisement response message, the previous access router 201 which has once transmitted the context advertisement message can place the upper limit of the number of hops of that advertisement message into a preferred condition by use of this result when again advertising the same or different context advertisement message.

In a case in which the upper limit of the number of hops of the context advertisement is set at a larger value, although there is a higher possibility that the context can be sent in advance up to the destination access router to which the mobile terminal moves, simultaneously with this, the context is transmitted to many communication devices which do not require it. For this reason, it is preferable to place the upper limit of the number of hops of the context advertisement into a suitable condition.

Although, as a method of knowing the number f hops, a description has been given of a method of adding a value of addition of the number of hops to a context advertisement message, it is also appropriate to employ a method of appending a value subtracted from the upper limit of the number of hops and a value set at the upper limit of the number of hops to a message. In addition, it is also appropriate to employ a method in which the previous access router 201 which is the transmission addresser of an advertisement message stores a value set at the upper limit of the number of hops and the destination access router 202 which transmits a context advertisement response message adds, to the context advertisement response message, the upper limit of the number of hops of the advertisement message at the reception by this communication device so as to calculate the number of actual hops on the basis of a difference between the upper limit (first set value) of the number of hops which was stored in the previous access router 201 and the value of the number of hops after the subtraction which was put in the response message.

Furthermore, referring to FIG. 5, a description will be given hereinbelow of a communication device in which, upon receipt of a message for the advertisement of a context, the terminal information retaining unit 304 retains the information on the context and the number of hops for the transfer of the message and, when the mobile terminal on the advertised context moves and an advertisement message is created for advertising the context, the message creating unit 305 sets the number of transfer hops included in the received advertisement message at the upper limit of the number of hops of an advertisement message to be newly created.

The previous access router 201 transmits the context advertisement message. This context advertisement message includes the information indicative of the upper limit of the number of hops and the information on the number of hops added for each transfer by a relay access router.

Thus, from the information on the number of hop included in the context advertisement message, the communication device which has transferred the context advertisement can grasp that what number hop this communication device is as the relay communication device.

When the mobile terminal 101 has moved to the place of a communication device which already received the context through the context advertisement message, the relay communication device behaves as a destination access router 701. This destination access router 701 behaves as previous access router in the next place due to the movement of the mobile terminal 101.

At this time, the access router 701 operating as previous access router can refer to the number of hops of the context advertisement message received from the previous access router 201 which is the first previous router so as to determine the upper limit of the number of hops of a context advertisement message this communication device transmits.

For example, in a case in which the number of hops from the previous access router 201 up to the access router 701 is 2, the context advertisement message where the upper limit of the number of hops is set at 2 is transmitted to a relay access router 702.

Incidentally, it is also acceptable that the upper limit of the number of hops is set at a value obtained by adding 1 to the number of hops of the received context advertisement message. Moreover, it is also possible to add an arbitrary value thereto.

Moreover, for the above-mentioned determination of the upper limit of the number of hops, it is also appropriate to employ a method of utilizing the number of hops included in a context advertisement response message for determining a preferable upper limit of the number of hops on the basis of both the information.

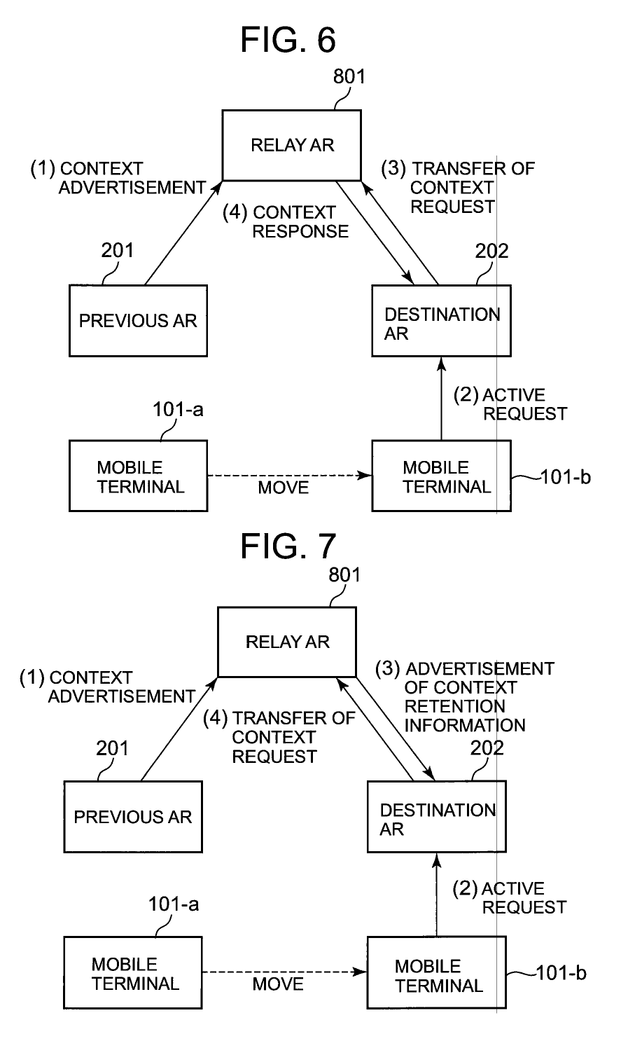

Furthermore, referring to FIG. 6, a description will be given hereinbelow of a communication device having a message creating unit 305 designed to, in a case in which the destination of a received context request message is not this communication device and this communication device is in a situation originally relaying the message but the requested context is held in the terminal information retaining unit 304, create a context response message without transferring the request message.

In FIG. 6, a relay access router 801 also serves as a proxy response access router which makes a proxy response.

The relay access router 801 receives a context advertisement from the previous access router 201 and retains the context information.

When transferring the context advertisement message, a relay communication device makes the transfer so as not to exceed the upper limit of the number of hops of the context advertisement message, so there is a case in which difficulty is experienced in advertising the context up to a destination communication device. A description will be given hereinbelow of a case in which a context advertisement does not reach the destination access router 202 yet.

When the mobile terminal 101-b has moved to the destination access router 202, since the destination access router 202 does not have the context on the mobile terminal 101, the destination access router 202 transmits a context request to the previous access router 201.

When this context request is just transferred and arrives at the relay access router 801, the relay access router 801 confirms whether or not the terminal information held in this communication device includes the information on the mobile terminal 101 and, since it has previously received the context advertisement and maintained the context on the mobile terminal 101, it returns a response to this context request by proxy in place of the previous access router 201.

That is, the relay access router 801 creates a context response message to a context request message as a proxy response access router in place of the previous access router 201 and transmits it toward the destination access router 202. In this case, the description that the transmission is made toward the destination access router 202 includes the meaning that this context response message is transmitted directly or indirectly as a transfer message toward the destination access router 202.

Thus, the context request can be transferred up to the previous access router 201 and the context can be delivered to the destination access router 202 while shortening the time for the returning of the context response.

Furthermore, referring to FIG. 7, a description will be given hereinbelow of a communication device in which, before creating and transmitting a context request message, the message creating unit 305 makes a request for the information on a list of communication devices having the requested context to a context requesting communication device and retains this list information in the relay communication device formation retaining unit 402 and creates a transfer message at the determination of a transfer addressee of the context request message so that the communication device having the context becomes a relay point.

Thus, the destination access router 202 can grasp the address of the previous access router 201 through an active request from the mobile terminal 101 at the transmission of a context request message, and when the destination access router 202 cannot transmit a context request directly because the destination access router 202 does not have the reliability with the previous access router, the destination access router 202 transfers a message through a communication device with which it has the reliability indirectly, thereby acquiring the context.

At this time, the destination access router 202 expects that a relay access router which transfers the context request message has previously received the context advertisement and directly makes an inquiry for the transfer addressee of the context at the previous access router 201 for grasping the relay access router which has the context.

In a case in which the previous access router 201 returns a response to this inquiry, the destination access router 202 transmits a context request transfer message so that it passes through the relay access router 801 having the context, and expects that the relay access router 801 makes a proxy response to this context request.

For the acquisition of the context, this enables more efficiently utilizing the relay access router, which makes a proxy response, in comparison with the case of continuing the transfer of the context request.

Furthermore, referring to FIG. 7, a description will be given hereinbelow of a communication device operating so that the message creating device 305 creates a message for advertising the retention of the context without advertising the context.

This provides the destination access router 202 with useful information for the determination of a request addressee of the context on the mobile terminal 101 when the context advertisement does not sufficiently arrive at the previous relay communication device.

The relay access router 801 receives a context advertisement and, when the transfer of this context advertisement is up to this communication terminal, further advertises, to a relay communication device beyond it, a message indicative of the fact that this communication device is holding the context.

This message for the notification on the retention of the context is useful provided that it includes the original address of the mobile terminal 101. When receiving this message and retaining that information in the terminal information retaining unit 304, a relay device can determine a transfer addressee of a context request when the mobile terminal 101 moves and transmits an active request.

In addition to the original address of the mobile terminal 101, it is also acceptable to include the information indicative of a hint at the transmission of a context request message. For example, it can include the address of the previous access router 201.

The use of this message of the notification on the retention of the context allows notifying a distribution situation of the context to communication devices in a wide range by means of a message shorter than that in the case of the advertisement of the context.

The above description was given of an example in which a relay communication device transmits a message for the notification on the retention of the context, it is also appropriate that a previous access router transmits it.

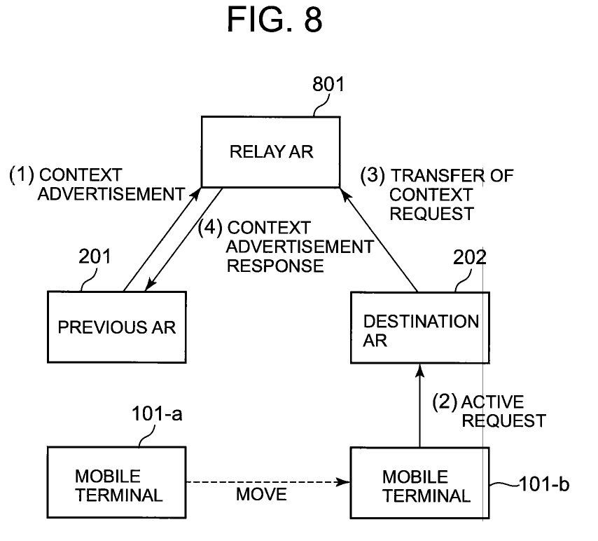

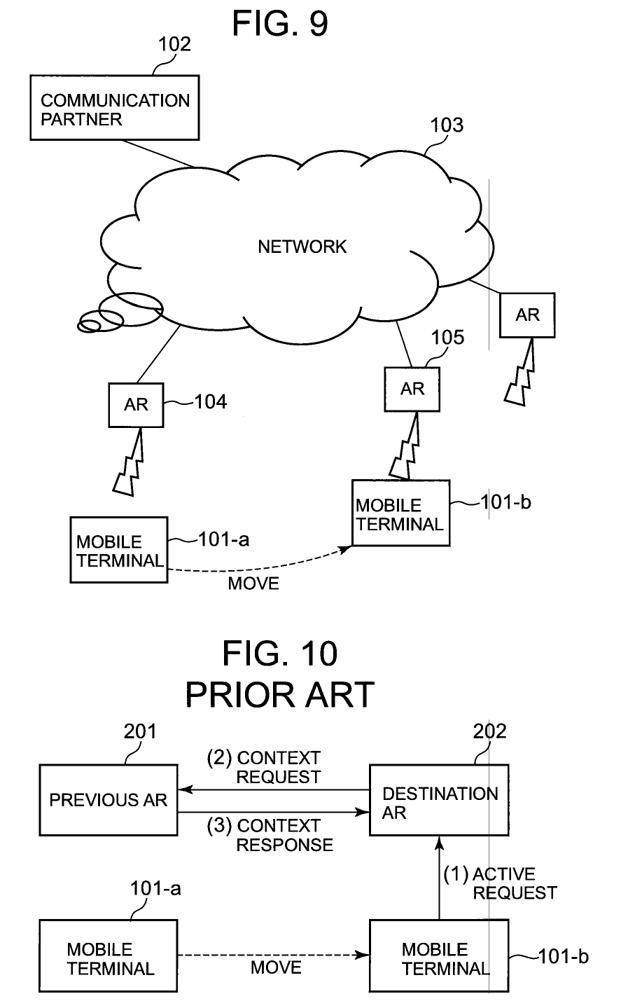

Furthermore, referring to FIG. 8, a description will be given hereinbelow of a communication device existing on a message transfer route between a context request addresser communication device and a context addressee communication device and retaining the number of hops from the context request addresser communication device to this communication device and the number of hops from the context request addressee communication device to this communication device. In this case, the message creating unit 305 thereof is designed to create a message for notifying the number of hops from the context request addressee to the context request addresser toward the context request addressee communication device.

The previous access router 201 transmits a context advertisement, and the information on the record of the number of times of transfer is included in the context advertisement message. Moreover, on the basis of the information on the record of the number of times of transfer of the context advertisement message, each relay communication device stores the number of times of transfer of the message by this communication device.

Moreover, the destination access router 202 transmits a context request, and the information on the record of the number of times of transfer is included in the context request message. Likewise, the relay communication device stores the number of times of transfer.

When a description will be given with reference to FIG. 8, the previous access router 201 transmits a context advertisement, and the relay access router 801 stores that the number of hops stands at 0. Moreover, when the mobile terminal 101 moves to the place of the destination access router 202, the destination access router 202 transfers a context request and the relay access router 801 receives it. The context request message also stores the fact that the number of times of transfer stands at 0.

The relay access router 801 transmits a context advertisement response toward the previous access router 201 as a response to the context advertisement from the previous access router 201. The number of hops from the destination access router 202 to the previous access router 201 is put in this context advertisement response. In the case shown in FIG. 8, the number of hops stands at 1.

In a case in which the information on the number of hops is added to the context advertisement response, when similar situation again occurs, the destination access router 201 can place the upper limit of the number of hops of the advertisement message into a preferred condition at the advertisement of a context advertisement.

This optimizes the advertisement of a context and enables the efficient utilization of network resources.

Furthermore, referring to FIGS. 6 and 5, a description will be given hereinbelow of a communication device existing on a message transfer route between a context request addresser communication device and a context addressee communication device and retaining the number of hops from the context request addresser communication device to this communication device and the number of hops from the context request addressee communication device to this communication device. In this case, the message creating unit 305 thereof is designed to create a message for notifying the number of hops from the context request addressee to the context request addresser toward the context request addresser communication device.

In the example shown in FIG. 5, the number of hops from the previous access router 201 is put in a context advertisement message as the information for determining the upper limit of the number of hops of the context advertisement message to be transmitted from the destination access router 701 to the relay access router 702.

However, in a case in which the context advertisement does not arrive at the destination access router 701, difficulty is experienced in using the number of hop included in this context advertisement message.

In a case in which the context advertisement does not arrive as mentioned above, when the mobile terminal 101 moves, the destination access router 202 transmits the transfer of the context request as shown in FIG. 6.

This context request message includes the number of hops of the message as information. Thus, the relay access router 801 grasps the number of hops from the destination access router 202 to the relay access router 801.

In addition, the relay access router 801 receives the context advertisement from the previous access router 201 and, since the number of hops is included in a message on the context advertisement, knows the number of hops from the previous access router 201 to the relay access router 801.

On the basis of these two information on the numbers of hops, the relay access router 801 knows the number of hops from the previous access router 201 to the destination access router 202. This information on the number of hops is notified through the use of a context response message to the destination access router 202.

By use of the information on the number of hops included in this context response message, the destination access router 202 determines the information indicative of the upper limit of the number of hops to be put in a context advertisement to be transmitted newly from this communication device.

Thus, a communication device can place the number of hops indicative of the number of times of transfer of a context advertisement message at the advertisement of a context.

In the case shown in FIG. 6, the number of hops of the context advertisement arriving from the previous access router 201 at the relay access router 801 stands at 0, and the number of hops of the context request arriving from the destination access router 202 at the relay access router 801 stands at 0. Accordingly, the relay access router 801 sets the number of hops at 1 in a context response and transmits it to the destination access router 202. The previous access router 201 utilizes the information indicative of the fact that the number of hops from the previous access router 201 to the destination access router 202 stands at 1, thereby determining the upper limit of the number of hops of the context advertisement to be transmitted from this communication device.

Incidentally, as a method of notifying the number of hops, from the previous access router 201 up to the destination access router 202, to the destination access router 202 through the use of a context response, it is also appropriate to employ a method of storing the number of hops at the arrival of a context advertisement from the previous access router 201 and setting this number of hops continuously in a context response. In this case, the number of hops for the transfer of a context response message is used continuously from the previous access router 201 and, at the arrival at the destination access router 202, it just shows the number of hops from the previous access router 201.

An embodiment of the present invention was described above.

The respective functional blocks used in the above description of the embodiment are typically realized with an LSI which is an integrated circuit. It is also acceptable that these blocks are individually formed as one chip, or that a portion of or all of these blocks are formed as one chip. Although an LSI is taken in this case, it is sometimes referred to as an IC, system LSI, super LSI or ultra LSI according to the level of integration. Moreover, the technique for the formation of an integrated circuit is not limited to the LSI, but it is also realizable with a dedicated circuit or a general-purpose processor. After the manufacturing of the LSI, it is also acceptable to utilize an FPGA (Field Programmable Gate Array) which enables the programming or a reconfigurable processor which allows the reconfiguration of connections and setting of circuit cells in the interior of the LSI. Still moreover, if a technique for the formation of an integrated circuit replaceable with the LSI app ears owing to advance in semiconductor technology or a different technology derived therefrom, the functional blocks can naturally be integrated through the use of this technique. For example, a biotechnology or the like may be applicable.

### INDUSTRIAL APPLICABILITY

A radio communication system, communication device, and relay device according to the present invention have a message transferring means for transferring a context, needed for making a connection of a mobile terminal with a network, at a higher speed between communication devices (between access routers) having a relationship of trust, and they are useful in an application such as a portable telephone network system including a mobile terminal.

1. A radio communication system comprising:
a first communication device connected through radio to a mobile terminal;
a second communication device with which said mobile terminal is placed through radio into connection after movement; and
at least one relay device made to relay a connection between said first communication device and said second communication device,
only devices having reliability with each other being connectable with each other,
said first communication device having no direct reliability with said second communication device, and said first communication device transmitting terminal information on said mobile terminal through at least said one relay device to said second communication device.

2. The radio communication system according to claim 1, wherein, when said first communication device transmits the terminal information, said second communication device which is a destination side of said mobile terminal is already specified and said second communication device specified is a transmission addressee of the terminal information.

3. The radio communication system according to claim 1, wherein, when said first communication device transmits the terminal information, said second communication device which is not specified is a transmission addressee of the terminal information.

4. (canceled)

5. The radio communication system according to claim 1, wherein said first communication device transmits the terminal information through at least said one relay device to said second communication device before the movement of said mobile terminal and,
when receiving a connection request from said mobile terminal after reception of the terminal information from at least said one relay device, said second communication device authenticates said mobile terminal on the basis of the terminal information and makes a connection of said mobile terminal.

6. (canceled)

7. The radio communication system according to claim 1, wherein said first communication device transmits the terminal information to at least said one relay device before the movement of said mobile terminal and,
upon receipt of a connection request from said mobile terminal, said second communication device transmits a request message, which is for transmission of the terminal information to said second communication device, to at least said one relay device and,
upon receipt of both the terminal information and the request message, at least said one relay device authenticates said mobile terminal by use of the request message and transmits the terminal information directly or through at least one different relay device to said second communication device.

8. The radio communication system according to claim 1, wherein said first communication device transmits the terminal information to at least said one relay device before the movement of said mobile terminal,
upon receipt of a connection request from said mobile terminal, said second communication device transmits a request message, which is for transmission of the terminal information to said second communication device, to at least said one relay device, and
upon receipt of both the terminal information and the request message, at least said one relay device authenticates said mobile terminal by use of the request message and transmits a response message for notification of the occurrence of a request for the terminal information on said mobile terminal directly or through at least one different relay device to said first communication device.

9. The radio communication system according to claim 1, wherein said first communication device transmits the terminal information to at least said one relay device before the movement of said mobile terminal,
upon receipt of the terminal information, at least said one relay device transmits a terminal information retention message for notification of retention of the terminal information directly or through at least one different relay device to said second communication device,
upon receipt of both the terminal information retention message and a connection request from said mobile terminal, said second communication device transmits a request message, which is for transmission of the terminal information to said second communication device, to at least said one relay device which retains the terminal information, and
at least said one relay device which retains the terminal information and which has received the request message authenticates said mobile terminal by use of the request message and transmits the terminal information directly or through at least one different relay device to said second communication device.

10. The radio communication system according to claim 1, wherein said first communication device transmits the terminal information to at least said one relay device before movement of said mobile terminal,
upon receipt of the terminal information, at least said one relay device transmits a terminal information retention message for notification of the retention of the terminal information directly or through at least one different relay device to said second communication device,
upon receipt of both the terminal information retention message and a connection request from said mobile terminal, said second communication device transmits a request message, which is for transmission of the terminal information to said second communication device, to at least said one relay device which retains the terminal information, and
at least said one relay device which retains the terminal information and which has received the request message authenticates said mobile terminal by use of the request message and transmits a response message, which is for notification of a request of the terminal information on said mobile terminal, directly or through at least one different relay device to said first communication device.

11. (canceled)

12. (canceled)

13. (canceled)

14. (canceled)

15. The radio communication system according to claim 1, wherein said first communication device transmits the terminal information through at least said one relay device to said second communication device before movement of said mobile terminal, and
upon receipt of a connection request from said mobile terminal after reception of the terminal information from at least said one relay device, said second communication device authenticates said mobile terminal by use of the terminal information and makes a connection of said mobile terminal and, after the connection of said mobile terminal, transmits a response message for notification of the connection of said mobile terminal through at least said one relay device to said first communication device,
the terminal information including the record of the number of hops taken until the arrival at said second communication while the response message including the number of hops recorded in the terminal information.

16. The radio communication system according to claim 1, wherein said first communication device transmits first terminal information through at least said one relay device to said second communication device before movement of said mobile terminal and,
upon receipt of a connection requirement from said mobile terminal after reception of the first terminal information from at least said one relay device, said second communication device authenticates said mobile terminal by use of the first terminal information and makes a connection of said mobile terminal and transmits second terminal information directly or through at least one different relay device to a third connection device which becomes a destination at further movement of said mobile terminal,
the first terminal information transmitted from said first communication device including the record of the number of hops taken until the arrival at said second communication device, and
in the second terminal information transmitted from said second communication device, the number of hops recorded in the first terminal information and taken until the arrival at said second communication device or a value larger than this number of hops being set as an upper limit value of the number of hops of the second terminal information.

17. (canceled)

18. The radio communication system according to claim 1, wherein said first communication device transmits the terminal information to at least said one relay device before movement of said mobile terminal,
upon receipt of a connection request from said mobile terminal, said second communication device transmits a request message, which is for transmission of the terminal information to said second communication device, to at least said one relay device, and
upon receipt of both the terminal information and the request message, at least said one relay device authenticates said mobile terminal by use of the request message and transmits a response message for notification of the occurrence of a request for the terminal information on said mobile terminal directly or through at least one different relay device to said first communication device,
the terminal information transmitted from said first communication device including the record of a first number of hops taken until the arrival at said relay device,
the request message transmitted from said second communication device including the record of a second number of hops taken until the arrival at said relay device, and
in said relay device which has received both the terminal information and the request message, the response message including both the first number of hops and the second number of hops or information on the sum total of the numbers of hops.

19. (canceled)

20. The radio communication system according to claim 1, wherein said first communication device transmits first terminal information to at least said one relay device before movement of said mobile terminal,
upon receipt of a connection request from said mobile terminal, said second communication device transmits a request message, which is for transmission of the first terminal information to said second communication device, to at least said one relay device, and
upon receipt of both the first terminal information and the request message, at least said one relay device authenticates said mobile terminal by use of the request message and transmits second terminal information directly or through at least one different relay device to said second communication device,
the first terminal information transmitted from said first communication device including the record of a first number of hops taken until the arrival at said relay device,
the request message transmitted from said second communication device including the record of a second number of hops taken until the arrival at said relay device, and
in said relay device which has received both the first terminal information and the request message, the second terminal information including both the first number of hops and the second number of hops or information on the sum total of the numbers of hops.

21. The radio communication system according to claim 1, wherein, upon receipt of a connection request from said mobile terminal after reception of the second terminal information including both the first number of hops and the second number of hops or information on the sum total of numbers of hops, said second communication device authenticates said mobile terminal by use of the second terminal information and makes a connection of said mobile terminal and transmits third terminal information directly or through at least one different relay device to a third communication device which becomes a destination at further movement of the said mobile terminal, and
in the third terminal information transmitted from said second communication device, a value of the sum of the first number of hops and the second number of hops or a value larger than this value is set as an upper limit of the number of hops of the third terminal information.

22. (canceled)

23. A communication device constituting a radio communication system, enabling a connection between only devices having reliability with each other, along with at least one relay device and connected through radio to a mobile terminal, wherein, when a connection partner of said mobile terminal is changed from said communication device to a different communication device due to movement of said mobile terminal, said communication device has no direct reliability with said different communication device, and said communication device transmits terminal information on said mobile terminal through at least said relay device to said different communication device.

24. The communication device according to claim 23, comprising:
a message receiving unit for receiving, through at least said one relay device, a request message transmitted from said different communication device which has received a connection request from said mobile terminal;
an authentication processing unit for authenticating said mobile terminal by use of the request message; and
a message transmitting unit for, when said mobile terminal is authenticated, transmitting the terminal information through at least said one relay device to said different communication device.

25. The communication device according to claim 23, comprising a message transmitting unit for, before movement of said mobile terminal, transmitting the terminal information through at least said one relay device to said different communication device.

26. The communication device according to claim 23, wherein the terminal information includes a count value of the number of hops and an upper limit value of the number of hops.

27. (canceled)

28. The communication device according to claim 25, further comprising:
a message receiving unit for receiving, through at least said one relay device, a response message transmitted from said different communication device, which has received a connection request from said mobile terminal, or from said relay device;
a message creating unit for, when the response message includes a first number of hops up to said different communication device which is a destination of said mobile terminal, a second number of hops up to said relay device and a third number of hops from said relay device up to said different communication device which is the destination or information indicative of a value of the sum of the second number of hops and the third number of hops, calculating a fourth number of hops up to said different communication device to create a transmission message in which the fourth number of hops is added to the terminal information; and
a message transmitting unit for transmitting the transmission message through at least said one relay device to said different communication device.

29. (canceled)

30. A communication device constituting a radio communication system, enabling a connection between only devices having reliability with each other, along with at least one relay device and connected through radio to a mobile terminal, wherein, when a connection partner of said mobile terminal is changed from a different communication device to said communication device due to movement of said mobile terminal, said communication device has no direct reliability with said different communication device, and said communication device receives terminal information on said mobile terminal from said different communication device through at least said relay device.

31. The communication device according to claim 30, comprising:
a message receiving unit for receiving a connection request from said mobile terminal;
a message creating unit for creating a request message for transmission of the terminal information from said different communication device; and
a message transmitting unit for transmitting the request message through at least said one relay device to said different communication device,
said message receiving unit receiving the terminal information, transmitted from said different communication device, through at least said one relay device after said different communication device authenticates said mobile terminal by use of the request message, and
a message analyzing unit for making a judgment as to whether the message received by said message receiving unit is the connection request or the terminal information.

32. The communication device according to claim 30, comprising:
a message receiving unit for receiving the terminal information retention message through at least said one relay device and then receiving a connection request from said mobile terminal;
a message creating unit for creating a request message for transmission of the terminal information from said relay device which has transmitted the terminal information retention message; and
a message transmitting unit for, after the reception of the connection request from said mobile terminal, transmitting the request message through at least said one relay device to said relay device which has transmitted the terminal information retention message.

33. The communication device according to claim 30, comprising:
a message receiving unit for receiving the terminal information, transmitted from said different communication device, through at least said one relay device before movement of said mobile terminal and for then receiving a connection request from said mobile terminal;
a message analyzing unit for making a judgment as to whether a message received by said message receiving unit is the connection request or the terminal information;
an authentication processing unit for authenticating said mobile terminal by use of the terminal information; and
a mobile terminal communication setting unit for, when said mobile terminal is authenticated, carrying out connection setting on said mobile terminal by use of the terminal information.

34. The communication device according to claim 33, comprising:
a message creating unit for, after the connection of said mobile terminal, creating a response message for notifying the connection of said mobile terminal; and
a message transmitting unit for transmitting the response message through at least said one relay device to said different communication device.

35. The communication device according to claim 33, comprising a message transmitting unit for, after the connection of said mobile terminal, transmitting the terminal information through at least said one relay device to said different communication device which becomes a destination of said mobile terminal.

36. (canceled)

37. The communication device according to claim 34, wherein the response message includes information indicative of the number of hops from said communication device to said different communication device.

38. (canceled)

39. (canceled)

40. A relay device constituting a radio communication system, enabling a connection between only devices having reliability with each other, along with a first communication device connected through radio to a mobile terminal before movement and a second communication device connected through radio to said mobile terminal after movement and having no direct reliability with said first communication device, and made to relay terminal information on said mobile terminal which is to be transmitted from said first communication device to said second communication device.

41. The relay device according to claim 40, comprising:
a message receiving unit for receiving the terminal information transmitted from said first communication device before the movement of said mobile terminal and for, when said second communication device receives a connection request from said mobile terminal, receiving a request message transmitted from said second communication device for transmission of the terminal information from said first communication device to said second communication device;
a message analyzing unit for making a judgment as to whether the message received by said message receiving unit is the terminal information or the request message;
an authentication processing unit for, when said message analyzing unit makes a judgment that the message is the request message, authenticating said mobile terminal by use of the request message; and
a message transmitting unit for, when said mobile terminal is authenticated, transmitting the terminal information directly or through at least one different relay device to said second communication device.

42. The relay device according to claim 40, comprising:
a message receiving unit for receiving the terminal information transmitted from said first communication device before the movement of said mobile terminal and for, when said second communication device receives a connection request from said mobile terminal, receiving a request message transmitted from said second communication device for transmission of the terminal information from said first communication device to said second communication device;
a message analyzing unit for making a judgment as to whether the message received by said message receiving unit is the terminal information or the request message;
an authentication processing unit for, when said message analyzing unit makes a judgment that the message is the request message, authenticating said mobile terminal by use of the request message;
a message creating unit for, when said mobile terminal is authenticated, creating a response message for notifying the authentication of said mobile terminal; and
a message transmitting unit for transmitting the response message directly or through at least one different relay device to said first communication device.

43. (canceled)

44. (canceled)

45. (canceled)

46. (canceled)

47. (canceled)

48. (canceled)

49. (canceled)
